(19) United States
(12) Patent Application Publication
(10) Pub. No.: US 2011/0124455 A1
(43) Pub. Date: May 26, 2011

(54) HYBRID DRIVE TRAIN OF A MOTOR VEHICLE

(75) Inventors: Kai Borntraeger, Langenargen (DE); Bernard Hunold, Friedrichshafen (DE); Max Bachmann, Bad Waldsee (DE); Rene Budach, Ravensburg (DE)

(73) Assignee: ZF FRIEDRICHSHAFEN AG, Friedrichshafen (DE)

(21) Appl. No.: 12/999,799

(22) PCT Filed: Jul. 16, 2009
(86) PCT No.: PCT/EP2009/059146

§ 371 Date: Dec. 17, 2010

(30) Foreign Application Priority Data
Jul. 17, 2008 (DE) 102008040498.5

(51) Int. Cl. B60K 6/365; F16H 3/44

(52) U.S. Cl. 475/5; 180/65.25; 903/902

(57) ABSTRACT

A hybrid drive train of a motor vehicle which comprises a combustion engine with a drive shaft and an electric machine which operates as either a motor or generator. The electric machine has a stator and a rotor and surrounds a planetary automatic transmission. The combustion engine drive shaft communicates, via a controllable separating clutch, and the rotor of the electric machine communicates, via the input transmission section, with the automatic transmission input shaft. The electric machine, the separating clutch, and the input transmission section are coaxially combined within a module enclosure of a preassembled hybrid module that has input and output elements. The input element is connected with the drive shaft of the combustion engine and the output element is connected with the input shaft of the automatic transmission, and the hybrid module maintains the dimensions of a conventional hydrodynamic torque converter.

This application is a National Stage completion of PCT/EP2009/059146 filed Jul. 16, 2009, which claims priority from German priority application serial no. 10 2008 040 498.5 filed Jul. 17, 2008.

### FIELD OF THE INVENTION

The invention concerns a hybrid drive train of a motor vehicle which comprises a combustion engine with a drive shaft, an electric machine which can be operated as either a motor or a generator, a stator as well as a rotor, and a multi-stage planetary automatic transmission with an input shaft and an output shaft, whereby the drive shaft of the combustion engine is drivingly connected via a controllable separating clutch, and the rotor of the electric machine, via an input transmission section, is drivingly connected with the input shaft of the automatic transmission.

### BACKGROUND OF THE INVENTION

A hybrid drive train in a motor vehicle, with a parallel operating configuration of a combustion engine and an electric machine, can be designed geometrically, from the drive technology standpoint as a configuration with a succeeding, multistage gear box, in a very simple manner, so that the electric machine is coaxially positioned on the input shaft of the gear box, the rotor of the electric machine is connected in a rotationally fixed manner with the input shaft of the gear box, and the drive shaft of the combustion engine can be connected with the input shaft of the gear box by means of a controllable, meaning an engaging/disengaging, separating clutch. The electric machine can, in this case, be forceless shifted during the drive operation, to use it either as a generator to charge the electric energy storage device, or as an electric motor to drive the motor vehicle. When applied as a motor, the electric machine can be used with the engaged separating clutch, especially in a larger acceleration and when driving on a steep uphill slope, to support the combustion engine in the so-called boost operation, and with a disengaged separating clutch especially during a starting and when driving in inner city areas with emission restrictions, using it as the only drive motor in a pure electric operation.

Such a hybrid drive train with a gear box, designed as a planetary automatic transmission, for instance, is known through the DE 103 46 640 A1. In both variations of this known hybrid drive train is, in accordance with the FIG. 1 and FIG. 2, in each case an electric machine, which is positioned coaxially above the input shaft of the automatic transmission, selectable to operate as motor or generator, and the rotor of the electric machine are in each case immediately connected in a rotationally fixed manner with the input shaft of the automatic transmission. The drive shaft of the combustion engine, provided with a torsional vibration damper, can be connected in each case via a controllable separating clutch with the input shaft of the automatic transmission. In addition, an output element in the hydraulic pump, used for the pressure and cooling oil supply for the shifting elements of the automatic transmission, is in a driving connection with the input shaft of the automatic transmission.

An additional kind of a hybrid drive train with a gear box, designed as a planetary automatic transmission, has been described with different embodiments in DE 10 2004 043 589 A1. While the first variation of this known hybrid drive train, based on its shown FIG. 1, largely matches the second embodiment of the hybrid drive train of the DE 103 46 640 A1, in accordance with its shown FIG. 2, the second variation of the known hybrid drive train as presented in DE 10 2004 043 589 A1 and its FIG. 2 shows an additional, second electric machine where the rotor is permanently in a driving connection with an output element of a provided hydraulic pump to generate pressure and cooling oil supply for the shifting elements of the automatic transmission and which, via an additional second separating clutch, can be connected to the drive shaft of the combustion engine. The second electric machine is designed to have a lower performance than the first electric machine and it is primarily applied as a starter for the combustion engine and as a pump drive for the hydraulic pump at a standstill of the combustion engine. Having two electric machines and two separating clutches, the mechanical and technical control effort is, however, unfavorably high in this second embodiment of the known hybrid drive train.

Generally, it is a disadvantage in the previously mentioned hybrid drive trains that the level of the rotation speed of the electric machine which is connected with the input shaft matches the rotation speed of the combustion engine, and that therefore the related electric machine, to achieve the necessary drive power for a pure electric drive condition, needs to be designed as being large and heavy.

By using an axially parallel configuration with the related electric machine and a driving connection of the rotor of the electric machine with the input shaft of a gear box via an input transmission section with a gear ratio i_{EK}>>1, like a spur gear or a continuously variable transmission, the electric machine can hereby designed as being significantly less powerful and therefore small and lightweight.

Such a hybrid drive train is, for instance, known through DE 100 12 221 A1 with two embodiments. In both embodiments of this known hybrid drive train and in accordance with FIG. 1 and FIG. 2 shown therein, a first electric machine, which can be operated as a motor or as a generator, is in each case positioned axially parallel with the input shaft of a main transmission, which can also be designed, among other options, as a planetary automatic transmission. The rotor of the first electric machine is in a driving connection, via the input transmission section with a high gear ratio (i_{EK}>>1), with the input shaft of the main transmission.

However, in this known hybrid drive train the radial dimensions are so large, especially in the area of the electric machine and the input transmission section, that this hybrid drive train cannot be integrated, without larger modifications to the vehicle body of the motor vehicle. In addition, due to the gear ratio of the input transmission section, the rotational speed of the rotor of the electric machine can be so high, that an unfavorably large effort is required for a rotational speed-proof design, as well as for the balancing and the bearing of the rotor.

Therefore, a requirement exists for a hybrid drive train of a motor vehicle which can be integrated with a motor vehicle by the use of an adequate electric machine for a pure electric operation, without modifications of the vehicle body as an alternative to a conventional drive train which comprises an automatic transmission with a hydrodynamic torque converter in front of it.

### SUMMARY OF THE INVENTION

Thus, it is the task of the present invention to present a hybrid drive train as previously described, which matches in a simple and space saving construction and without any functional restrictions, the dimensions of a conventional drive train with hydraulic dynamic torque converters. In addition, a suitable bearing for the rotor of the applied electric machine shall be presented.

To solve the given task, the invention is based on a hybrid drive train of a motor vehicle, which comprises a combustion engine with a drive shaft, an electric machine used as a motor or generator with a stator and a rotor, and with a multistage planetary automatic transmission with an input shaft and an output shaft, whereby the drive shaft of the combustion engine, via a controllable separating clutch, and the rotor of the electric machine, via a transmission input section, are drivingly connected with the input shaft of the automatic transmission. It is also provided, in accordance with the invention, that the electric machine, the separating clutch, and the transmission input section are coaxially positioned in a module enclosure which can be preassembled with an input element and an output element, whereby the input element is connected in a rotationally fixed manner with the drive shaft of the combustion engine, and the output element is connected in a rotationally fixed manner with the input shaft of the automatic transmission, and the hybrid module matches the dimensions of a conventionally used hydrodynamic torque converter.

Therefore, the invention is essentially an assembled unit which represents a hybrid module, comprising of the electric machine, the separating clutch, and the transmission input section, whereby, due to the coaxial positioning of these parts, an especially compact construction is achieved, through which the dimensions of an existing hydrodynamic torque converter, in a conventional drive train, can be maintained without any decrease in the functionality.

The input element of the hybrid module is, analogous to the pump wheel shaft of a torque converter, practically designed as a shaft or a flanged shaft, which can be, for instance, during the assembly of the hybrid drive train, connected in a rotationally fixed manner through a plug-in connection or screw type flange, respectively, with the crankshaft of the combustion engine or with one of its connected flywheels. Analogous to the turbine wheel hub of a torque converter, it is also practicable if the output element of the hybrid module is designed as a hub which, for instance, can be connected in a rotationally fixed manner during the assembly of the hybrid drive train via an interlock gearing with the axially protruding input shaft of the automatic transmission.

The hybrid drive train, in accordance with the invention, differs only, apart from a larger energy storage for the electric machine which can be positioned at a different location within the motor vehicle, for instance under the backseat or in the trunk, from a conventional drive train through the provided hybrid module, instead of the hydrodynamic torque converter. The planetary automatic transmission of the conventional drive train can be maintained in the invented hybrid drive train without any changes, whereby, contrary to known hybrid drive trains, a large number of gear steps and a large spread are available. In addition, due to the total, larger production quantity of the consolidated automatic transmission, significant cost advantages arise as compared to known solutions with specific transmission configurations. Advantageous is also, in regard to the integration of the invented hybrid drive train with a motor vehicle, that no modification of the vehicle body is required.

To achieve compact dimensions of the hybrid module, it is preferably provided that the electric machine is designed as an inner, radially positioned rotor, inside of the stator, and that the separating clutch is axially positioned on the motor side and that the input transmission section is axial, in reference to the transmission, radial positioned within the rotor.

To effectively diminish the unavoidable, torsional vibrations of the crankshaft, generated by the drive shaft of a piston engine, the input element of the hybrid module can also be designed as two parts which are rotatable to a limited extent, which are connected with each other via a torsional vibration damper. Hereby, the torsional vibration damper is also a part of the hybrid module and can be positioned axially, on the motor side, either radially inside or at least close to the rotor of the electric machine.

To achieve, on one hand, a compact configuration and, on the other hand, a preferably high efficiency of the electric machine, the input transmission section is appropriately designed with a transmission ratio I_{EK} between 1.2 and 1.7 (1.2<I_{EK}<1.7).

Such a transmission ratio I_{EK}, in connection with compact dimensions, can be achieved by designing the input transmission section as a simple planetary gear wheel set which has a sun gear, with several pivotable planetary gear wheels which are circumferentially distributed and positioned on a planetary carrier, where the planetary wheels also intermesh with a ring gear, whereby the sun gear is fixed in position opposite to the module enclosure, the ring gear is connected in a rotationally fixed manner with the rotor of the electric machine, and the planetary carrier is connected in a rotationally fixed manner with the output element of the hybrid module.

The transmission ratio I_{EK} of the input transmission section is, depending on the particular number of teeth, exactly between 1.25 and 1.67 (1.25<I_{EK}<1.67). An advantage of that design of the transmission input section is also the relatively low rotational speed between the rotating parts, like between the sun gear and the planetary carrier, and between the planetary carrier and the ring gear, which hereby results altogether in a high efficiency transmission.

The rotor of the electric machine can be pivoted, in a simple and space saving way through a double shear bearing, comprising an axially fixed bearing at the motor side of the input transmission section, and an axially positioned non-locating bearing at the transmission side of the input transmission section, opposite to the module enclosure and/or at a pivoted part within the module enclosure.

At least one of the bearings, meaning the fixed bearing and/or the non-locating bearing of the rotor of the electric machine, is practically designed as a rolling bearing, which supports itself radially inside on an enclosure mounted outer cylindrical bearing seat, which can, for instance, be part of a bearing shield which is a fixed part with the enclosure.

However, the non-locating bearing of the rotor can also be designed as a rolling bearing which supports itself radially inside on an external, cylindrical bearing seat, which is mounted at a part that is connected in a rotationally fixed manner with the output element of the hybrid module, such as a driving element of a hydraulic pump, driven by the output element. The generated radial forces of the non-locating bearing are, in this case, transmitted via the bearing of the output element of the hybrid module into the module enclosure.

The rolling bearing which is used as the fixed bearing and/or the non-locating bearing, are each preferably designed as deep groove ball bearings. A standardized deep groove ball bearing is robust as well as inexpensive, and can, due to the design and load directions, be applied as a non-locating bearing as well as a fixed bearing.

The non-locating bearing of the rotor of the electric machine can also be designed especially advantageous through the gearings and bearings of the parts of the input transmission section, whereby the construction space and the cost for a separate roller bearing can be spared. Through this preferred design of the input transmission section as a simple planetary gear set, the generated radial forces of the non-locating bearing are mainly transmitted by the rotor of the electric machine via the gearing of the ring gear and from the planetary gears to the planetary carrier, and from here transmitted via the bearing of the output element of the hybrid module into the module enclosure.

However, as an alternative to a double shear bearing, the rotor of the electric machine can also be pivoted positioned by means of a single fixed bearing, axially positioned at the motor side of the input transmission section, which is opposite the module enclosure, or at a pivoted part which is within the module enclosure. Axial stress which is generated by the input transmission section or the ring gear of the planetary gear wheel set, respectively, is compensated in this bearing design through axial movement of the ring gear and, if required, through the planetary gear wheels which are opposite to the planetary carrier and/or through an elastic information of the rotor of the electric machine.

The fixed bearing of the rotor is practically configured by means of a rolling bearing configuration, which supports itself, radially inside, on an enclosure mounted, outer cylindrical bearing seat.

To be able to accommodate, beside the usual occurrence of radial and axial forces, also the tilting and bending torque of the rotor which is caused by the operation, the fixed bearing of the rotor is in this case preferably designed as a double-row angular ball bearing, or as an adjusted bearing with two tapered roller bearings.

### BRIEF DESCRIPTION OF THE DRAWINGS

For a further clarification of the invention, drawings are attached to the specification with examples of the embodiments. It is shown in

FIG. 1 a schematic presentation of the invented hybrid drive train with a hybrid module;

FIG. 2 the hybrid module as in FIG. 1 with a first bearing of the rotor of the electric machine;

FIG. 3 the hybrid module as in FIG. 1 with a second bearing of the rotor of the electric machine;

FIG. 4 the hybrid module as in FIG. 1 with a third bearing of the rotor of the electric machine;

FIG. 5 the hybrid module as in FIG. 1 with a fourth bearing of the rotor of the electric machine; and

FIG. 6 the hybrid module as in FIG. 1 with a fifth bearing of the rotor of the electric machine.

### DETAILED DESCRIPTION OF THE PREFERRED EMBODIMENTS

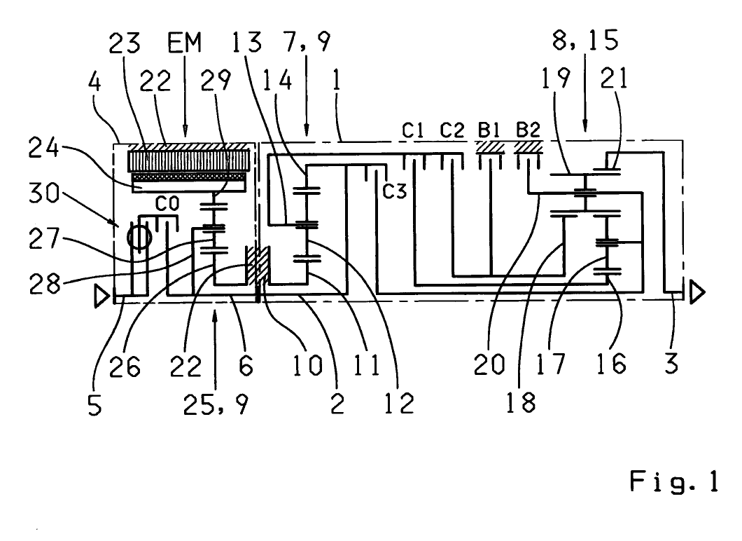

The invented drive train as in FIG. 1 has a planetary automatic transmission 1 with an input shaft 2, as well as an output shaft 3 which has here, instead of a hydrodynamic torque converter, an upstream positioned hybrid module 4 with an input element 5 and an output element 6.

The automatic transmission 1 comprises a partial transmission 7 on the input side and a partial transmission 8 on the output side which is positioned between the input shaft 2 and the output shaft 3 which are switchable through a selective engagement of the shift-clutches C1, C2, C3, and to shift brakes B1, B2.

The partial transmission 7 on the input side is designed as a simple planetary gear assembly 9 with a sun gear 11, which is fixed in position with reference to an enclosure 10, with a group of planetary gears 12, which mesh with the sun gear 11 and which are together rotatably positioned on the planet carrier 13, and with a ring gear 14 which meshes with the planetary gears 12 and which is permanently, connected in a rotationally fixed manner with the input shaft 2.

The partial transmission 8 on the output side is designed as a Ravigneaux gear set 15, with a first, radially small sun gear 16 which meshes with a first group of axially shorter planetary gears 17, with a second radial larger sun gear 18 which meshes with a second group of axially longer planetary gears 19, which each mesh with one of the axially shorter planetary gears 17, with a planet carrier 20 on which the axially shorter planetary gears 17 and the axially longer planetary gears 19 are rotatably positioned, and with a ring gear 21 which meshes with the axially longer planetary gear 19 and which is permanently, connected in a rotationally fixed manner with the output shaft 3.

The radially smaller sun gear 16 can be connected, by means of the first shift clutch C1, selectively with the planetary carrier 13 of the partial transmission 7 at the input. The radially larger sun gear 18 can be connected, by means of the second shift clutch C2, selectively with the planetary carrier 13 of the partial transmission 7 at the input. The planetary carrier 20 at the output side can be connected, by means of the third shift clutch C3, selectively with the input shaft 2. The radially larger sun gear 18 can be locked by means of the first shift brake B1, opposite in reference to the enclosure 10. Finally, the planetary carrier 20 can be locked by means of the second shift brake B2, opposite in reference to the transmission enclosure 10.

This known automatic transmission has six forward gear steps G1 to G6 and one reverse gear step R, each can be shifted through the selective engagement of two shift elements, meaning two of the shift clutches C1, C2, C3 and the shift brakes B1, B2.

The hybrid module 4 comprises an electric machine EM, designed to work as a motor and as a generator, and a controllable, meaning an engaging and disengaging, separating clutch C0 for the required connecting or disconnecting of the combustion engine which is in a driving connection with the input element 5. The electric machine EM is designed as an inner rotor and a radially, outer stator 23, attached to the module enclosure 22, as well as a rotor 24 which is positioned radially within the stator 23.

The rotor 24 is in driving connection, via the input transmission section 25, with the output element 6. The input transmission section 25 is designed as a simple planetary gear set 9 and, at the transmission side, axially positioned coaxial within the cavity of the electric machine EM which is formed by the rotor 24. The input transmission section 25 comprises a sun gear 26 which is permanently attached to the module enclosure 22, a group of planetary gears 27 which mesh with the sun gear 26 and which are rotatable positioned on a common planetary carrier 28, and a ring gear 29 which meshes with the planetary gears 27 and which is permanently, connected in a rotationally fixed manner with the rotor 24 of the electric machine EM. The input transmission section 25 represents therefore a gear ratio i_{EK}, which varies between 1.25 and 1.67 (1.25<i_{EK}<1.67).

The separating clutch C0 which is connected on the input side, via a torsional vibration damper 30, in a rotationally fixed manner with the drive shaft of the combustion engine (not shown here) and its input element 5, and connected on the output side directly with the output element 6 of the hybrid module 4, and is axial positioned, on the motor side, coaxial within the rotor 24 of the electric machine EM.

Due to the design and the positioning of the electric machine EM, the separating clutch C0, and the input transmission section 25, the hybrid module 4 maintains, without any functional restrictions, the dimensions of a hydrodynamic torque converter of a conventional drive train. The inventive hybrid drive train as in FIG. 1 can therefore simply be integrated as an alternative with a conventional drive train of a motor vehicle and, if necessary, be assembled in a common manufacturing line.

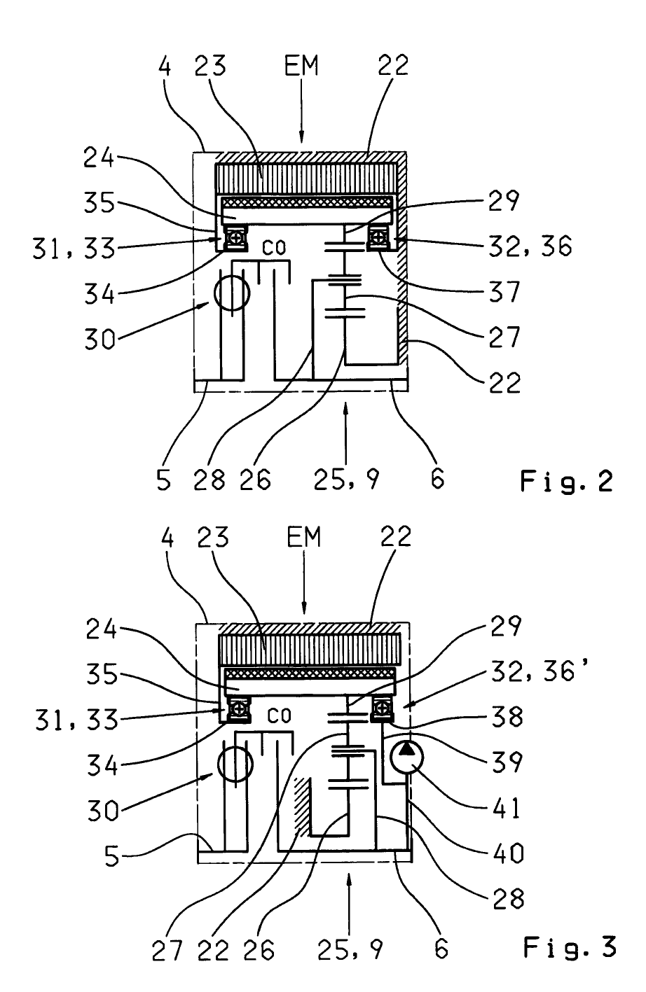

In FIGS. 2 to 6, examples of different bearings of the rotor 24 of the electric machine EM are shown, each in an enlarged partial section of FIG. 1 which presents the hybrid module 4, in this case just in schematic form and quite simplified.

In the embodiment of the hybrid module 4 in accordance with FIG. 2, the rotor 24 of the electric machine EM is rotatably positioned through a double support bearing, comprising an axially fixed bearing 31, on the motor side of the input transmission section 25, and an axial non-locating bearing 32, pivotably designed and opposite in reference to the module enclosure 22, at the transmission side of the input transmission section 25. The fixed bearing 31 of the rotor 24 is created by means of a rolling bearing 33, designed as a deep groove ball bearing, which supports itself radially, inside, on an outer cylindrical bearing seat 34, which is part of the fixed bearing shield 35, provided as part of the enclosure. The non-locating bearing 32 of the rotor 24 is created through a rolling bearing 36, designed as a groove ball bearing, which supports itself radially, inside, on an outer cylindrical bearing seat 37 which is connected with the module enclosure 22.

In the variation of the hybrid module 4, in accordance with FIG. 3, the rotor 24 of the electric machine EM, is again designed as a double support bearing, comprising of an axially fixed bearing 31, positioned on the motor side of the input transmission section 25, and an axial non-locating bearing 32, positioned at the transmission side of the input transmission section 25. In contrast to the previously described embodiment in accordance with FIG. 2, the non-locating bearing 32 of the rotor 24 is now, designed as a deep groove ball bearing, a rolling bearing 36′, which supports itself radially, inside on an outer cylindrical bearing seat 38, which is by means of a bearing disk 39 mounted in a rotationally fixed manner to an output element 40 of a hydraulic pump 41 which is connected with the output element 6 of the hybrid module 4. The generated radial forces of the non-locating bearing 32 are transferred in this case via the bearing of the output element 6 into the module enclosure 22.

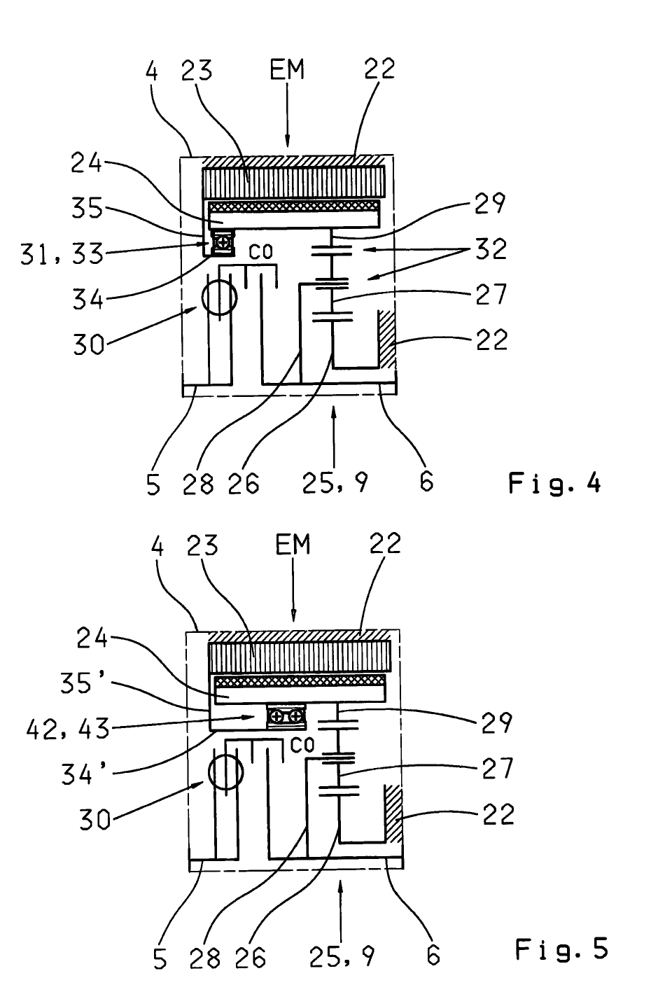

In a variation of the hybrid module 4 in accordance with FIG. 4, contrary to the embodiments in FIG. 2 and FIG. 3, a rolling bearing is not provided for the non-locating bearing 32 of the rotor 24 of the electric machine EM. The non-locating bearing 32 of the rotor 24 is generated in this case through the gear meshing and the bearings of the parts 26, 27, 28, 29 of the input transmission section 25. The generated radial forces of the non-locating bearing 32 are in this case essentially transferred via the gear meshing of the ring gear 29 and the planetary gears 27 to the planetary carrier 28, and from here via the bearing of the output element 6 into the module enclosure 22.

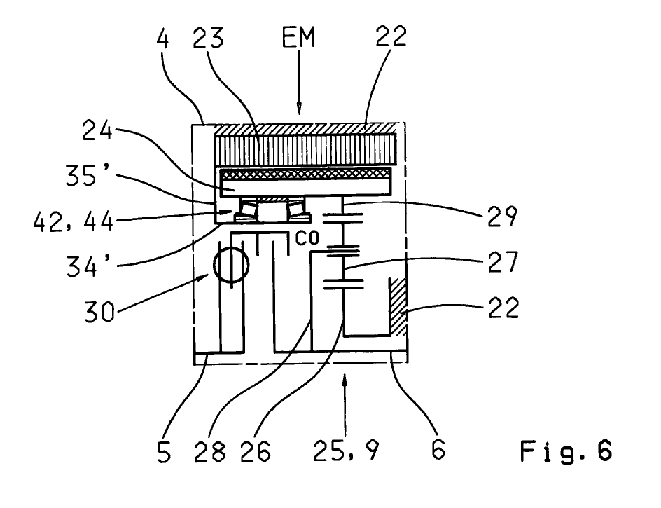

In the variations of the hybrid module 4 in accordance with FIG. 5 and FIG. 6, the rotor 24 of the electric machine EM is in each case pivotably mounted axially on the motor side of the input transmission section 25, via a single, fixed bearing 42 which is positioned opposite to the module enclosure 22. The fixed bearing 42 of the rotor 24 is in each case created through a rolling bearing configuration 43, 44, which supports itself radiall, inside on an outer cylindrical bearing seat 34′, which is part of the bearing shield 35′ provided through the enclosure.

The roller bearing configuration in the embodiment as in accordance with FIG. 5 is designed as a double-row angular ball bearing 43 and, in the variation in accordance with FIG. 6, designed as an adjusted bearing 44 by means of two tapered roller bearings. The axial stress which comes from the input transmission section 25, or the ring gear 29 of the planetary gear assembly 9, respectively, are compensated in these bearing designs by means of an axial shift of the ring gear 29 and, if necessary, by means of the planetary gears 27 in reference to the planetary carrier 28 and/or by means of an elastic deformation of the rotor 24 of the electric machine EM.

### REFERENCE CHARACTERS

1 Automatic Transmission
2 Input Shaft
3 Output Shaft
4 Hybrid Module
5 Input Element
6 Output Element
7 Partial Transmission, input side
8 Partial Transmission, output side
9 Planetary Gear Assembly
10 Enclosure
11 Sun Gear
12 Planetary Gear
13 Planet Carrier
14 Ring Gear
15 Ravigneaux Gear Set
16 Sun gear
17 Planetary Gear
18 Sun Gear
19 Planetary Gear
20 Planetary Carrier
21 Ring Gear
22 Module Enclosure
23 Stator
24 Rotor
25 Transmission Input Section
26 Sun gear
27 Planetary Gear
28 Planetary Carrier
29 Ring Gear
30 Torsional vibration damper
31 Fixed Bearing
32 Non-locating Bearing
33 Rolling Bearing, Deep Groove Ball Bearing
34 Bearing Seat
34′ Bearing Seat
35 Bearing Shield
35′ Bearing Shield
36 Rolling Bearing, Deep Groove Ball Bearing
36′ Rolling Bearing, Deep Groove Ball Bearing
37 Bearing Seat
38 Bearing Seat
39 Bearing Disc
40 Output Element
41 Hydraulic Pump
42 Fixed Bearing
43 Rolling Bearing Configuration, Double-row angular ball bearing
44 Rolling Bearing Configuration, adjusted bearing
B1 Switching Brake
B2 Switching Brake
C0 Separating Clutch
C1-C3 Shift Clutch
EM Electric Machine
G1-G6 Forward Gear Steps
EM Electric Machine
G1-G6 Forward Gear Step
I_{EK} Gear Ratio of the Input Transmission Section
R Reverse Gear Step

1-15. (canceled)

16. A hybrid drive train of a motor vehicle comprising:
a combustion engine with a drive shaft,
an electric machine (EM) which operates as a both motor and a generator, and the electric machine (EM) having a stator (23) and a rotor (24), and
a multistage planetary automatic transmission (1) with an input shaft (2) and an output shaft (3),
the drive shaft of the combustion engine, via a controllable separating clutch (C0), and the rotor (24) of the electric machine (EM), via an input transmission section (25), each being in a driving connection with the input shaft (2) of the automatic transmission (1),
the electric machine (EM), the separating clutch (C0), and the input transmission section (25), being coaxially combined in a preassembled hybrid module (4) within a module enclosure (22), and the module enclosure (22) having an input element (5) and an output element (6),
the input element (5) being connected, in a rotationally fixed manner, with the drive shaft of the combustion engine and the output element (6) being connected, in a rotationally fixed manner, with the input shaft (2) of the automatic transmission (1) so that the hybrid module (4) maintains dimensions of a conventionally used hydrodynamic torque converter.

17. The hybrid drive train according to claim 16, wherein the electric machine (EM) has a rotor (24) radially positioned within the stator (23), the separating clutch (C0) is axially positioned on a motor side, and the input transmission section (25) is axially positioned on a transmission side, radially within the rotor (24).

18. The hybrid drive train according to claim 16, wherein the input element (5) of the hybrid module (4) comprises of two parts which are limited in rotation with respect to each other and are connected to each other via a torsional vibration damper (30).

19. The hybrid drive train according to claim 16, wherein the input transmission section (25) has a gear ratio (i_{EK}) of between 1.2 and 1.7 (1.2<i_{EK}<1.7).

20. The hybrid drive train according to claim 19, wherein the input transmission section (25) comprises a simple planetary gear assembly (9) with a sun gear (26), a plurality of planetary gears (27) that are rotationally supported by and circumferentially distributed on a planetary carrier (28) and which mesh with the sun gear (26), and the planetary gears (27) mesh with a ring gear (29), the sun gear (26) is fixedly connected with the module enclosure (22), and the ring gear (29) is connected with the rotor (24) of the electric machine (EM), and the planetary carrier (28) is connected with the output element (6) of the hybrid module (4).

21. The hybrid drive train according to claim 16, wherein the rotor (24) of the electric machine (EM) is rotatably supported via a double support bearing, which comprises a fixed bearing (31) that is axially located on a motor side of the input transmission section (25) and non-locating bearing (32) that is at least one of axially located on a transmission side of the input transmission section (25), which is opposite in reference to the module enclosure (22) and via a supported part (6, 40) in the module enclosure (22).

22. The hybrid drive train according to claim 21, wherein the fixed bearing (31) of the rotor (24) is a rolling bearing (33) which is radially support within an inside of an outer cylindrical bearing seat (34) which is part of the module enclosure (22).

23. The hybrid drive train according to claim 21, wherein the non-locating bearing (32) of the rotor (24) is a rolling bearing (26) which is supported radially inside on an outer cylindrical bearing seat (37) which is part of the module enclosure (22).

24. The hybrid drive train according to claim 21, wherein the non-locating bearing (32) of the rotor (24) is a rolling bearing (36′) which is supported radially inside on an outer cylindrical bearing seat (38) which is mounted to a part (40) which is connected, in a rotationally fixed manner, with the output element (6) of the hybrid module (4).

25. The hybrid drive train according to claim 21, wherein the rolling bearing (33, 36, 36′), which forms at least one of the fixed bearing (31) and the non-locating bearing (32) of the rotor (24), is a deep groove ball bearing.

26. The hybrid drive train according to claim 21, wherein the non-locating bearing (32) of the rotor (24) is achieved by meshings and bearings of parts (26, 27, 28, 29) of the input transmission section (25).

27. The hybrid drive train according to claim 16, wherein the rotor (24) of the electric machine (EM) is one rotationally supported by a single fixed bearing (42) that is axially positioned on a motor side of the input transmission section (25), opposite the module enclosure (22), and rotationally supported by a supported part of the module enclosure (22).

28. The hybrid drive train according to claim 27, wherein the fixed bearing (42) of the rotor (24) of the electric machine (EM) comprises a rolling bearing configuration (43, 44) which is radially supported one of within and on a quarter cylindrical bearing seat (34′) that forms part of the module enclosure (22).

29. The hybrid drive train according to claim 28, wherein the fixed bearing (42) of the rotor (24) is a double row angular ball bearing (43).

30. The hybrid drive train according to claim 28, wherein the fixed bearing (42) of the rotor (24) is an adjustable bearing (44) by two tapered roller bearings.
